(19) United States
(12) Patent Application Publication
(10) Pub. No.: US 2006/0038499 A1
(43) Pub. Date: Feb. 23, 2006

(54) Monitoring apparatus with connector

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 10/920,336

(22) Filed: Aug. 18, 2004

(51) Int. Cl. H05B 37/02

(52) U.S. Cl. 315/149

(57) ABSTRACT

A monitoring apparatus with a connector is disclosed. The monitoring apparatus is inserted directly into a device, such as bulb socket or power socket, to which electric power has been supplied thereby the monitoring apparatus can be operated automatically through the supplied electric power. The present invention comprises a main body used as a monitoring apparatus. A camera is mounted on the main body 1 to capture an image transmitted to a processing control unit for processing and transmitted outwardly through a wireless transceiver module to achieve the monitoring purpose. Thereafter, the captured image can be stored into a storage device. A connector is mounted on one end of the main body 1, the connector can be a lamp head to be mounted directly on a lamp socket, and the connector can be a power plug to be inserted into a power socket for obtaining electric power. The main body can be connected to a lamp to provide with the illumination purpose at the same time. The present invention can be directly mounted without wiring. Thus, the present invention can be assembled easily, and is suitable to be mounted at a high and faraway place. Moreover, it is convenient to maintain the present invention.

### BACKGROUND OF THE INVENTION

The present invention relates to a monitoring apparatus with connector, and more particularly to a connector that is mounted directly on a device, for example, a bulb socket or a power socket, to which electric power has been supplied, and no wiring is required for operation by using the device to which electric power is supplied.

Monitors are always mounted on public places, buildings, stores, or residence houses. In order to monitor various locations, monitors are usually mounted on every indoor and outdoor nook, and mostly on the high places. Since wiring of power distribution is needed for these monitors, climbing on a high or low place cannot avoid. It is very inconvenient. After the monitors are mounted, the later maintenance, which is concerned with wiring, is inconvenient.

Further, bulb sockets, which are used to provide with illumination, are generally mounted on every location of the stores, display place, or inside of building, wherein the configuration for supplying with electric power has been set on these bulb sockets. Moreover, other configuration for supplying with electric power has been set on, for example, power source sockets. Since the monitors cannot work without electric power, the inventor tries to combine them or utilize a location, which provides electric power directly, to provide the monitoring function directly. Accordingly, numerous wirings will not be required any more, thus the use of the present invention is provided with convenience.

### SUMMARY OF THE INVENTION

The main purpose of the present invention is to provide a monitoring apparatus with a connector in which a lamp head type connector is utilized to mount the present invention directly on the lamp socket. The present invention can be operated to perform the monitoring step through electric power supplied by the lamp socket, and can be coupled to a lamp to provide with an illumination function, thus dual purposes including illumination and monitoring purposes can be achieved. Accordingly, the assembling step can be accomplished readily due to no wiring. The present invention with easy maintenance is suitable to be mounted on a high and faraway place.

Another purpose of the present invention is to provide a monitoring apparatus with a connector; the present invention can be mounted directly on the lamp socket through a power plug type connector without additional electric cord. Thus, it is convenient to assemble and maintain the present invention.

According to the aforementioned purpose of the present invention, there is provided with a main body, which is a monitoring apparatus and comprises a processing control unit for processing and controlling signal data; a camera for capturing an image transmitted to the processing control unit; a transceiver module for transmitting image data outwardly to perform the monitoring step; and a storage device, which is a flash memory card or a hard disk, for storing the captured image data, wherein a memory card slot is mounted on the main body for receiving a memory card to store image data.

A connector, which is a lamp head or a power plug, is electrically connected to the main body to be mounted on a device, which is a lamp socket or a power socket, to which electric power has been supplied to obtain electric power.

A lamp is electrically connected to the main body to provide with illumination purpose.

The above described transceiver module is a wireless transceiver module or a wired transceiver module. The wireless transceiver can receive the remote control signal to turn on or turn off the monitoring apparatus and the lamp. The wireless transceiver module comprises a bluetooth module, wireless FM system, infrared ray wireless transmission, Wifi, RFID (Radio Frequency Identification Code), etc. The transceiver module is a Homeplug-compliant (powerline home networking specification) chipset to transmit data through the existent indoor power cord.

The present invention further comprises a sensor connected to the processing control unit to transmit the sensor signal to control the turn on or turn off step. On the other hand, various sensors can be utilized to drive the processing control unit to perform various monitoring steps, such as increase resolution, close up, continuous capture, etc.

The present invention further comprises a switch that is connected to the lamp to turn on or turn off the light.

The present invention further comprises a timer that is connected to the switch to turn on or turn off the lamp at a predetermined time automatically, and is further connected to the processing control unit to turn on or turn off the monitoring apparatus at the predetermined time.

Thus, the present invention can be mounted directly on several indoor lamp sockets through lamp head type connectors, or inserted into sockets through power plug type connectors. Once electric power is supplied, the present invention can be operated as a lamp to illuminate and to achieve the monitoring purpose. Thus, the monitoring apparatus with simple assemblage and maintenance is provided.

The aforementioned aspects and advantages of the present invention will be readily clarified in the hereafter description of examples of preferred embodiments of the present invention, in reference with the enclosed drawings.

The present invention intends to cover all alternatives and arrangements of these alternatives. Nevertheless, the selected preferred embodiment is described in the specification and illustrated in the accompanying drawings.

### BRIEF DESCRIPTION OF THE DRAWINGS

FIG. 1. is an outward-appearance of the present invention.

FIG. 2 is a block diagram showing a composition of the present invention.

FIG. 3-1 is a side view of the present invention mounted on the lamp socket.

FIG. 3-2 is a bottom view of the present invention mounted on the lamp socket.

FIG. 4 is a schematic diagram showing another preferred embodiment of the present invention.

FIG. 5 is a schematic diagram showing still another preferred embodiment of the present invention

FIG. 6 is a schematic diagram showing a socket type connector of the present invention.

FIG. 7 is a schematic diagram showing another socket type connector of the present invention.

FIG. 8 shows a socket type connector of another preferred embodiment of the present invention.

### DETAILED DESCRIPTION OF THE PREFERRED EMBODIMENT

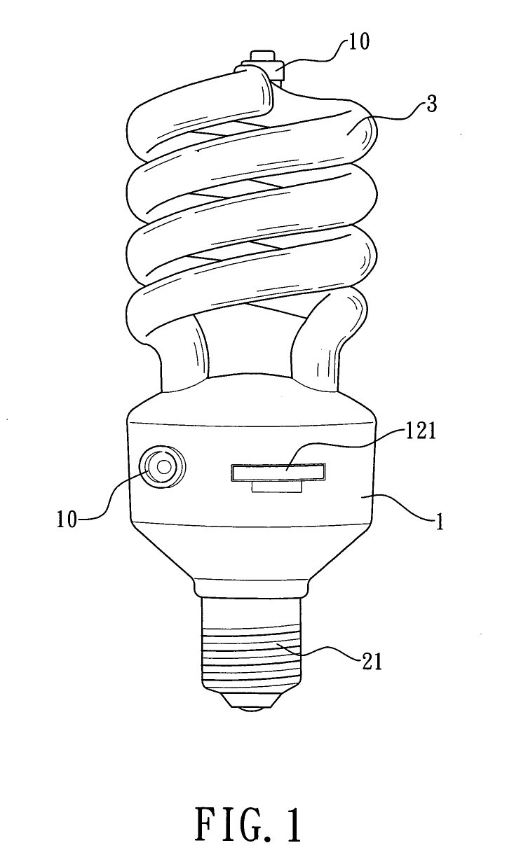

FIG. 1 is a schematic diagram showing an outward-appearance of the present invention. As shown in FIG. 1, the present invention comprises a main body 1 as a monitoring apparatus. A connector, which is a lamp head 21 to be mounted on the lamp socket, is mounted on one end of the main body 1. A lamp 3, which is a bulb or a tube, is mounted on the other end of the main body 1. The lamp 3 is electrically connected to the lamp head 21 to provide with the function of illumination.

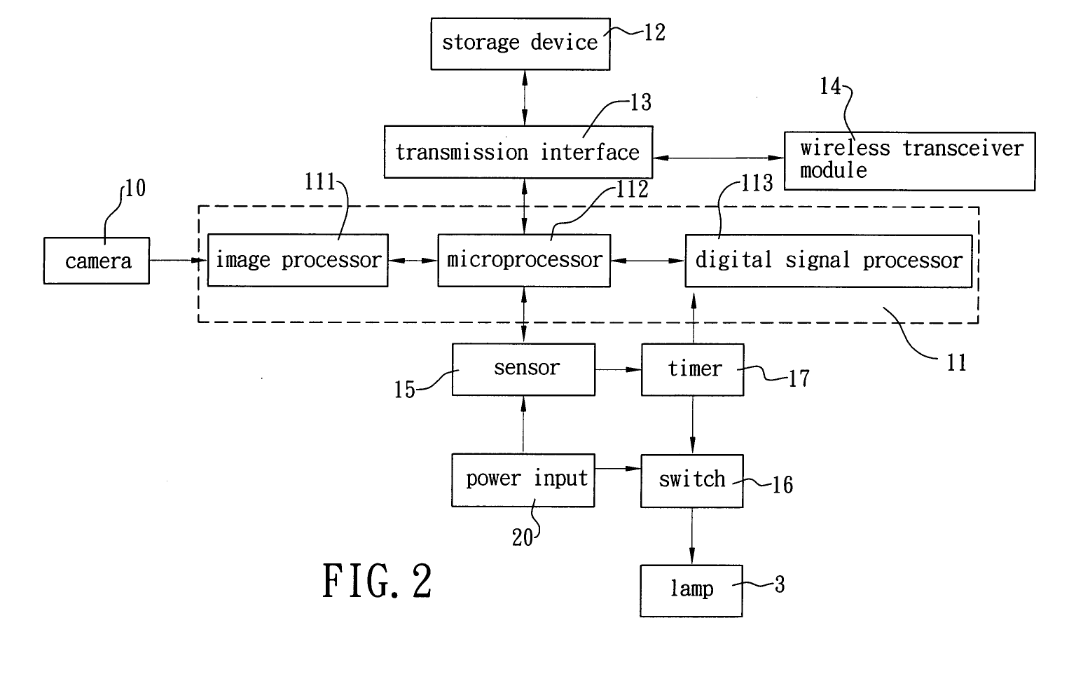

FIG. 2 is a block diagram showing a composition of the present invention. As shown in FIG. 2, the main body 1 is a monitoring apparatus. A camera 10 for capturing image is mounted on the main body 1. The camera 10 can be also mounted on the lamp 3 to capture images from different locations and angles.

A processing control unit 11, which is used for processing and controlling signal data, comprises an image processor 111 connected to the camera 10 for processing and compressing the captured image signal; a microprocessor 112 for processing and controlling signal data; and a digital signal processor 113 connected to the microprocessor 112 for digitizing the image signal.

A storage device 12, which is used to store the captured image data and can be a flash memory card or a hard disk, is connected to the microprocessor 112 through a transmission interface 13. A memory slot 121 for receiving the memory card to store the image data is mounted on the main body 1.

A wireless transceiver module 14 is connected to the transmission interface 13 to transmit the captured image data so as to watch and monitor thereof. The wireless transceiver module 14 can receive the remote switching signal to turn on or turn off the monitoring apparatus and the lamp 3 respectively. The wireless transceiver module 14 comprises blue tooth module, wireless FM system, infrared ray wireless transmission, Wifi, Radio Frequency Identification Code (RFID), etc. By using its identification function, the RFID can recognize different persons to determine that whether the monitoring process or a further instruction, such as close-up function, etc, should be enabled or executed respectively.

A sensor 15 is connected to the microprocessor 112 to transmit a sensor signal to the microprocessor 112 to turn on or turn off thereof. On the other hand, various sensors 15 can be utilized to drive the processing control unit 11 to perform various monitoring steps, such as increase resolution, close up, continuous capture, etc.

A switch 16 is connected to the lamp 3 to turn on or turn off the lamp.

A timer 17 is connected to the switch 16 to turn on or turn off the lamp at a predetermined time automatically, and further connected to the processing control unit 11 to turn on or turn off the monitoring apparatus at a predetermined time.

A power input 20 is mounted on the lamp socket to input electric power through the connector of the lamp head 21.

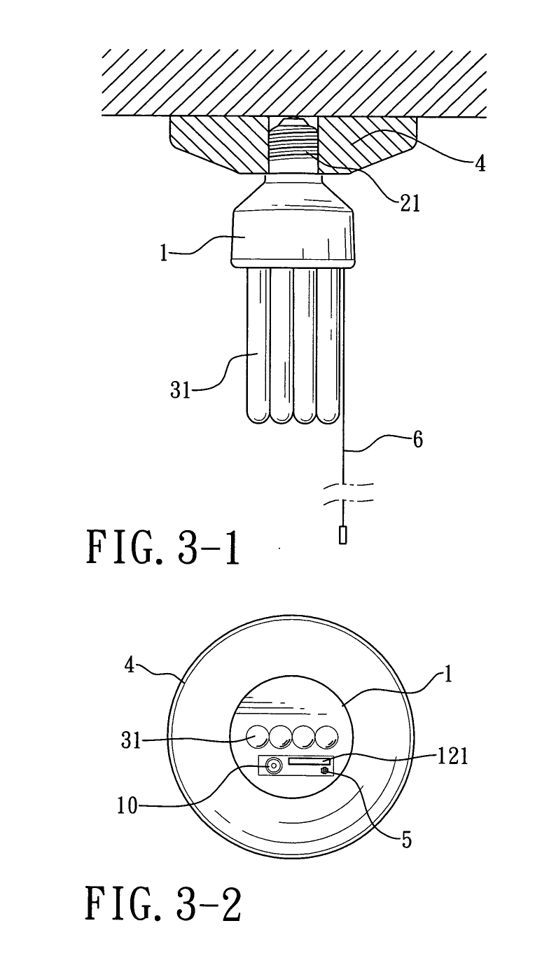

Referring to FIG. 3-1 and FIG. 3-2, which are side view and bottom view of the present invention mounted on the lamp socket. The lamp head 21 is locked directly on the lamp socket 4 and electrically connected thereto to input electric power. Several lamp tubes 31 are mounted on the main body 1, and a camera 10 for capturing the image is mounted on the bottom end of the main body 1. A memory card slot 121 is mounted on the bottom end of the main body 1 for receiving a memory card to store the image data. Additionally, a microphone 5 for recording is mounted on the main body 1. A cord switch 6 connecting to the switch 16 is mounted on the main body 1 so as to achieve the control purpose from the low position.

According to the above description, the lamp head 21 is utilized to enable the present invention to be mounted directly on the lamp socket 4, thus no wiring is required. In other words, the present invention to which electric power has been supplied can be mounted readily and directly to achieve the monitoring purpose. The present invention is especially suitable for operation on a high and faraway place such as a tall building or a remote mountain. Since there is no problem caused of wiring, the replacement can be reached by using a tall pole, namely, it is not necessary to climb to a high place, and the maintenance of the present invention becomes easier. The present invention combines the lamp illumination with the image monitoring, namely, the lamp is provided with the function of monitoring image, and it is practical and convenient. When the present invention is mounted on various locations, the wireless transceiver module 14 can be utilized to transmit the captured image data outwardly, or Homeplug-compliant (powerline home networking specification) chipset can be assembled to transmit the image data through the existent indoor power cord. Thus, images of various locations can be captured.

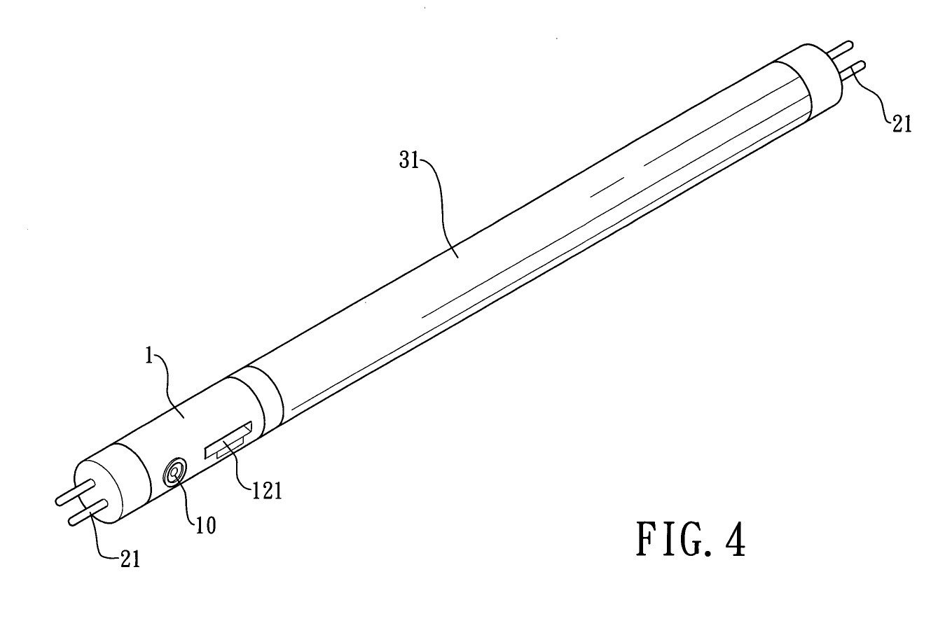

FIG. 4 is a schematic diagram showing another preferred embodiment of the present invention. In this preferred embodiment, as shown in FIG. 4, the present invention is an apparatus in the form of a fluorescent lamp. The main body 1 is coupled to the lamp tube 31 to form a fluorescent tube. Lamp heads 21 mounted on both ends of the fluorescent tube are in the form of pins for inserting into the fluorescent tube socket to input electric power. A camera 10 for capturing image and a memory card slot 121 for storing the captured image data into the memory card are mounted on the main body 1.

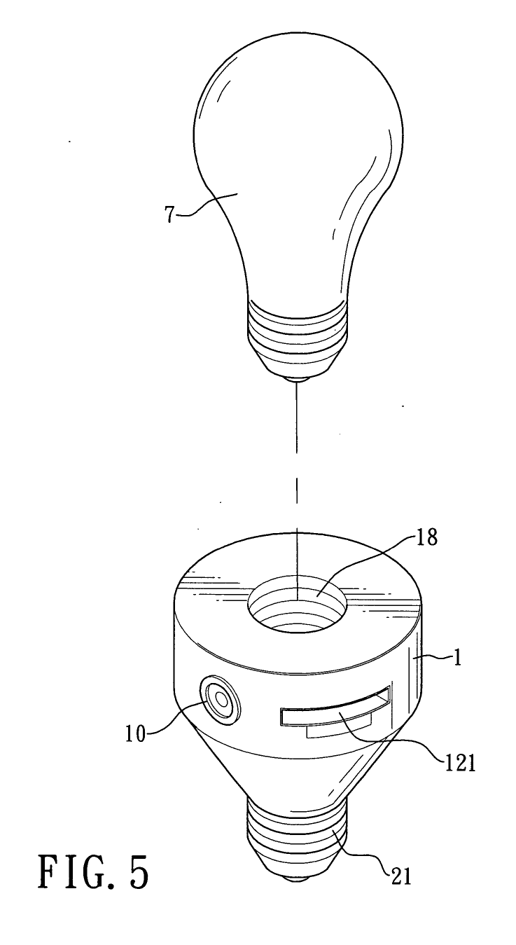

FIG. 5 is a schematic diagram showing still another preferred embodiment of the present invention. As shown in FIG. 5, a lamp head 21 mounted on a bulb socket is electrically connected to one end of the main body 1. A bulb-fixing socket 18 is mounted on the other end of the main body 1 for receiving the existent bulb 7, thus the existent bulb can be upgraded to provide with the monitoring function.

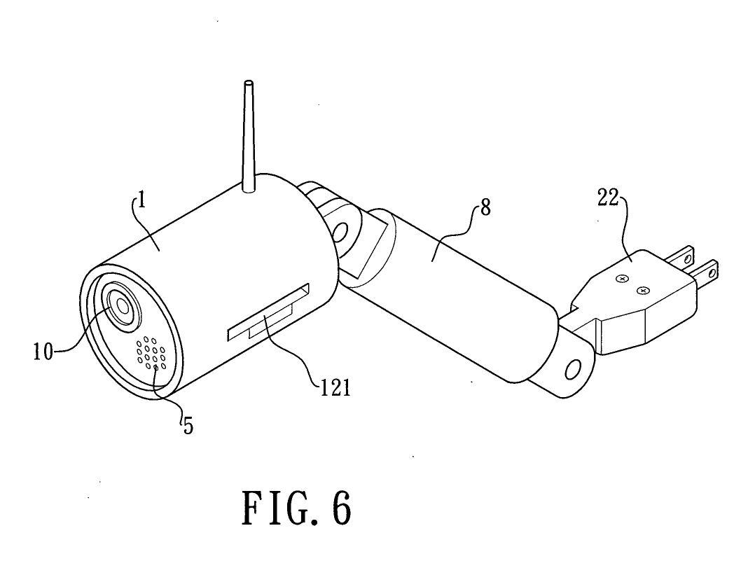

FIG. 6 is a schematic diagram showing a socket type connector of the present invention. Referring to FIG. 6, the connector is a power plug 22 that can be plugged into a power socket, thus it can work without wiring. The main body 1 is pivotally connected to a movable arm 8 that is pivotally connected to the power plug 22 so that the position and angle of the main body 1 can be adjusted by rotation. A memory card slot 121 is mounted on the main body 1 for receiving the memory card to store image data. A camera 10 for capturing image is mounted in the front end of the main body 1. A microphone 5 for recording by inputting sound is mounted in the front end of the main body 1. Since no wiring and maintenance are required for the present invention, it is simple and economical. In addition, once electric power is supplied, the monitoring step can be executed. It is more convenient to assemble and use the present invention, and quite suitable for assembling at a high and faraway place.

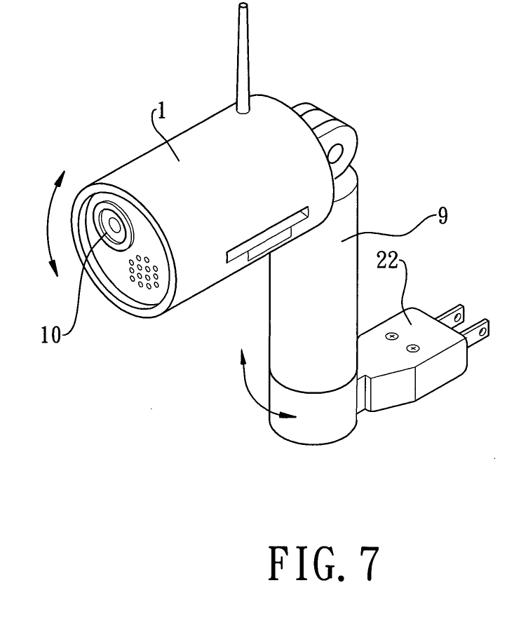

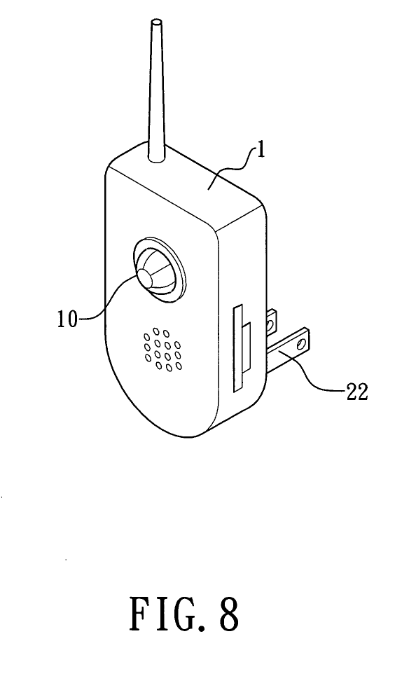

FIG. 7 is a schematic diagram showing another socket type connector of the present invention. Please refer to FIG. 8, the main body 1 is pivotally connected to a rotator 9 that is able to rotate on both sides. The rotator 9 is pivotally connected to the power plug 22. When the power plug 22 is plugged into the power socket, the rotator 9 can drive the main body 1 to rotate on both sides to capture the images in different directions. The main body 1 can be rotated upward and downward relating to the rotator 9 to adjust an image capture angle of the camera.

FIG. 8 shows the socket type connector of another preferred embodiment of the present invention. Please refer to FIG. 8, the power plug 22 is mounted directly on the main body 1. A camera 10 that can be rotated at 360 degrees is mounted on the main body 1 so as to adjust the image capture angle.

Therefore, as is understood by a person skilled in the art, the present invention achieves the aforementioned purpose according to the above description and satisfies requirements of patent law. The application for a patent is therefore submitted.

As is understood by a person skilled in the art, the foregoing preferred embodiments of the present invention are illustrated of the present invention rather than limiting of the present invention. It is intended that various modifications and similar arrangements be included within the spirit and scope of the appended claims, the scope of which should be accorded the broadest interpretation so as to encompass all such modifications and similar structure.

What the invention claimed is:

1. A monitoring apparatus with a connector comprising:
a main body comprising: a processing control unit to process and control the signal data; a camera for capturing an image and transmitting the image to the processing control unit; a transceiver module for transmitting the image data to monitor thereof; a storage device for storing the captured image data; and
a connector electrically connected to the main body for mounting on a device to which electric power has been supplied to obtain electric power.

2. The monitoring apparatus with a connector of claim 1, wherein the connector is a lamp head for mounting on a lamp socket.

3. The monitoring apparatus with a connector of claim 1, wherein the connector is a power plug for inserting into a power socket.

4. The monitoring apparatus with a connector of claim 2, wherein further comprises a lamp that is electrically connected to the connector.

5. The monitoring apparatus with a connector of claim 2, wherein a bulb-fixing socket is mounted on the main body 1 to utilize an existent bulb.

6. The monitoring apparatus with a connector of claim 1, wherein the transceiver module is a wireless transceiver module.

7. The monitoring apparatus with a connector of claim 1, wherein the transceiver module is a Homeplug-compliant (powerline home networking specification) chipset to transmit data through an existent indoor power cord.

8. The monitoring apparatus with a connector of claim 1, wherein a timer connected to a switch is mounted on the main body to turn on or turn off the light at a first predetermined time, and the timer is also connected to the processing control unit to turn on or turn off the monitoring apparatus at a second predetermined time.

9. The monitoring apparatus with a connector of claim 1, wherein further comprises a sensor connected to the processing control unit to transmit a sensor signal to turn on or turn off thereof, and a different sensor for a different monitoring purpose is utilized to drive the processing control unit.

10. The monitoring apparatus with a connector of claim 3, wherein the main body is pivotally connected to a movable arm, and the movable arm is pivotally connected to the power plug.

11. The monitoring apparatus with a connector of claim 3, wherein the main body is pivotally connected to a rotator, and the rotator being able to rotate on both sides is pivotally mounted on the power plug.
